(19) United States
(12) Patent Application Publication
(10) Pub. No.: US 2007/0185884 A1
(43) Pub. Date: Aug. 9, 2007

(54) Aggregating and presenting information on the web

(75) Inventor: Raj Gopal Prasad Kantamneni, Sunnyvale, CA (US)

Correspondence Address: BEYER WEAVER LLP, P.O. BOX 70250, OAKLAND, CA, 94612-0250, US

(73) Assignee: YAHOO! Inc.

(21) Appl. No.: 11/350,401

(22) Filed: Feb. 7, 2006

(51) Int. Cl. G06F 17/30

(52) U.S. Cl. 707/10

(57) ABSTRACT

Methods and apparatus are described for aggregating and presenting information in a network. A plurality of information sources relating to a category of subject matter are identified. Each information sources represents content from an associated site on the network. Each site has at least one parameter associated therewith representative of reliability with respect to the category. The content is periodically received from each of the plurality of information sources. The content received from the information sources via the network is indexed in a database. A portion of the content from the database is presented to a user via the network. The portion of the content corresponds to an index specified by the user.

### BACKGROUND OF THE INVENTION

The present invention relates to aggregation of information in a network and, more specifically, to techniques for aggregation and presentation of information on the World Wide Web which is relevant to particular individuals and/or communities.

The information available on the World Wide Web is increasingly vast and diverse. As a result, search technologies continue to become correspondingly sophisticated. However, currently deployed search engines are often inefficient or inadequate for some of the most common types of searching in which typical Web users are engaged. For example, many users search the Web for the best deals on consumer goods. This typically involves entry of relevant keywords, e.g., “DVD players,” in a search engine search box, followed by an iterative process of reviewing and refining the search results until currently available deals for the desired product are identified.

Unfortunately, because of the typically large number of search results returned, users are never comfortable that they have found the best deals, or that specific offers or coupons relating to a particular product have been or can be readily identified. This uncertainty may be exacerbated by the presentation of sponsored links which, while often identifying relevant suppliers of the sought after goods or services, may not necessarily represent deals which satisfy the user's criteria.

In addition, many offers and deals on the Web are time sensitive and may only be available for very short periods of time, e.g., minutes or hours. The manner in which information is typically indexed on the Web makes it unlikely that conventional search technologies will be able to produce search results which include such time-sensitive information. As a result, even though users may be aware of the existence of such offers or deals, the often do not search for them because they have no expectation that they will be able to find them. Thus, the purpose of providing such deals is frustrated for both consumers and merchants.

Web sites and blogs exist which attempt some level of aggregation for the benefit of other users, e.g., sites or blogs which discuss or post information rating consumer products or services. However, the relevancy and reliability of such sites wax and wane unpredictably (and often rapidly) as experienced users continually migrate to the most relevant and reliable sources of information. Unfortunately, such declines in relevancy and reliability are typically not apparent to less experienced users for whom the relevancy and reliability of such information are the most critical. Again, because of the manner in which they index information, conventional search technologies are generally not able to track such migrations in a timely manner.

It is therefore desirable to provide techniques by which reliable information on the Web which is relevant to a particular individual or community may be aggregated and presented in a timely manner.

### SUMMARY OF THE INVENTION

According to the present invention, information is aggregated in a network from a plurality of carefully selected and reliable sources of information (e.g., RSS feeds) deployed on the network. Portions of the aggregated information are then presented to users in the network according to indices specified by the users.

According to a specific embodiment, methods and apparatus are provided for aggregating and presenting information in a network. A plurality of information sources relating to a category of subject matter are identified. Each information source represents content from an associated site on the network. Each site has at least one parameter associated therewith representative of reliability with respect to the category. The content is periodically received from each of the plurality of information sources. The content received from the information sources via the network is indexed in a database. A portion of the content from the database is presented to a user via the network. The portion of the content corresponds to an index specified by the user.

According to a more specific embodiment, at least some of the information sources are RSS feeds. According to various embodiments, the portion of the content may be presented to the user in a variety of ways. For example, the portion of the content may be presented with search results generated in response to a search query from the user specifying the index. Alternatively, the portion of the content may be presented as part of a Web page customized by the user. According to a specific embodiment, the content may include deal information relating to a plurality of products, and the portion of the content presented to the user may include the deal information corresponding to at least one of the plurality of products. According to another specific embodiment, the index is derived from a browsing context associated with the user, and the portion of the content presented on the client machine is presented in combination with the browsing context.

According to a specific embodiment, methods and apparatus for aggregating and presenting information in a network are provided. Specification of an index by a user on a client machine is facilitated. Presentation of a portion of content from a database on the client machine is facilitated. The content corresponds to the index specified by the user and is derived from a plurality of information sources deployed on the network relating to a category of subject matter corresponding to the index. Each of the information sources represented in the database corresponds to an associated site on the network having at least one parameter associated therewith representative of reliability with respect to the category.

A further understanding of the nature and advantages of the present invention may be realized by reference to the remaining portions of the specification and the drawings.

### BRIEF DESCRIPTION OF THE DRAWINGS

FIG. 1 is a simplified network diagram of an exemplary network in which embodiments of the present invention may be implemented.

FIG. 2 is a flowchart illustrating a specific embodiment of the invention.

FIG. 3 is a table illustrating exemplary information in a database derived from a number of information sources according to a specific embodiment of the invention.

FIGS. 4-7 are exemplary screen shots illustrating presentation of information generated according to various embodiments of the present invention.

### DETAILED DESCRIPTION OF SPECIFIC EMBODIMENTS

Reference will now be made in detail to specific embodiments of the invention including the best modes contemplated by the inventors for carrying out the invention. Examples of these specific embodiments are illustrated in the accompanying drawings. While the invention is described in conjunction with these specific embodiments, it will be understood that it is not intended to limit the invention to the described embodiments. On the contrary, it is intended to cover alternatives, modifications, and equivalents as may be included within the spirit and scope of the invention as defined by the appended claims. In the following description, specific details are set forth in order to provide a thorough understanding of the present invention. The present invention may be practiced without some or all of these specific details. In addition, well known features may not have been described in detail to avoid unnecessarily obscuring the invention.

Embodiments of the present invention aggregate and index information from selected RSS feeds, and then present portions or “slices” of that information according to indices or keywords specified by particular users. For example, a database of current consumer electronics deals could be generated by subscribing to a number of RSS feeds from merchant sites on the Web, and indexing the information as it comes in via the various feed subscriptions. Then when a user enters “DVD players” in a search box, results could be returned from the database which identify current information relating to DVD players.

“RSS” refers to a family of XML dialects for Web syndication which is in widespread use on the Web today. The abbreviation is used to refer to several different but at least conceptually related standards. For example, for RSS 0.91, RSS stands for Rich Site Summary; for RSS 0.9 and 1.0, it stands for RDF Site Summary; and for RSS 2.0, it stands for Really Simple Syndication. In its various forms, RSS allows Web users to subscribe to Web sites that provide RSS feeds. These subscriptions allow the users to be alerted to changes or additions to site content. The various RSS formats provide web content or summaries of web content together with links to the full versions of the content, and other meta-data. This information is delivered as to the subscriber as an XML file which is referred to as the RSS feed.

RSS feeds are well suited for use with various embodiments of the invention due to their widespread use and well understood format. However, it should be noted that the various types of RSS feeds are merely a subset of the type of information which may be aggregated according to the various embodiments of the present invention. That is, any source of information on a network which is reliable and relevant with respect to particular subject matter, and to which an aggregator can subscribe or gain access may be employed to implement the invention. The postings on the web log of an expert in a particular field, text on the pages of a popular product rating Web site, and vendor databases are examples of other sources of information which could be used. Thus, the scope of the invention should not be limited to RSS feeds.

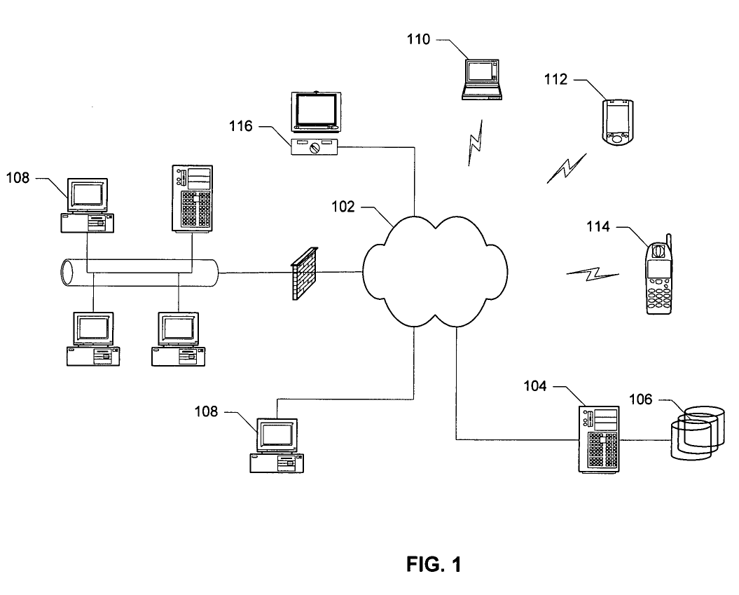

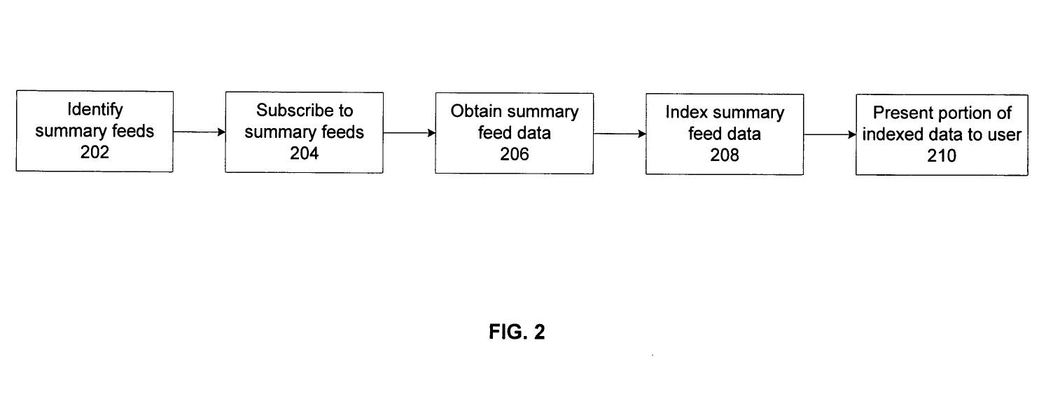

FIG. 1 is an exemplary network diagram in which embodiments of the present invention may be implemented. FIG. 2 is a flowchart illustrating operation of a specific embodiment of the invention. It will be understood that the network depicted in FIG. 1 and the process depicted in FIG. 2 are merely presented for exemplary purposes, and that the present invention is not limited thereto. For example, network 102 may include any combination of local and wide area networks, and may represent all or portions of the Internet, the World Wide Web, wired and wireless telecommunications networks, satellite networks, cable networks, etc. In addition, individual computing devices may represent one or multiple devices. Similarly, the flowchart of FIG. 2 merely depicts one possible way of implementing the invention.

An aggregator (represented by server 104) identifies some number of sources of information, e.g., RSS feeds, associated with sites relating to particular subject matter which is or may be of interest to a particular category of subject matter or community of users (202). The aggregator then subscribes to the identified RSS feeds (204). A software process associated with the aggregator pings the RSS feeds on a periodic basis to obtain new posting information (206). As data are obtained from the selected RSS feeds, they are indexed into one or more databases, e.g., database(s) 106 (208).

According to various embodiments, the frequency with which RSS feed data are retrieved may vary depending on the application. For example, depending on the characteristics of a particular market, these data may be obtained with a periodicity which ranges from seconds to days. Information in the database is then presented to users (represented by desktops 108, laptop 110, PDA 112, wireless phone 114, and set top box 116) in a variety of forms and in response to a variety of actions (210).

The manner in which the information sources are identified and selected may vary according to different embodiments of the invention. For example, according to some embodiments, a human operator may select the RSS feeds by researching the Web, referring to his own experience, and/or soliciting information from subject matter experts and from a relevant community of users. Alternatively, RSS feeds may be identified in an automated fashion with reference to a wide variety of parameters such as, for example, the level of traffic to particular sites, the number of subscriptions to particular RSS feeds, etc.

In addition, the RSS feeds for a particular database may change over time due to increases or decreases in relevancy for a particular community or market. In some cases, a human operator can periodically review the set of RSS feeds to determine whether they are providing the type of information which is still relevant to the user community. Again, this may be accomplished through Web research and user feedback, as well as analysis of the usage of the aggregated information by the community over time. As will be understood, this may also be done by an automated process. In any case, such a mechanism will ensure that the most relevant information is being indexed.

The extent to which users feel they can trust that the results are timely, relevant, and reliable greatly affects the effectiveness of the techniques described herein. Therefore, according to specific embodiments of the present invention, the selection of RSS feeds with which a database is populated is carefully done with the relevant user community in mind. That is, for example, if the database is intended to be populated with data relating to a particular category of consumer products, only the RSS feeds from the most reputable and/or popular online merchants or reviewers might be used.

According to specific embodiments, the most relevant and reliable information sources may be determined by human operators, automated processes, or a combination of both. For example, a human operator (who may be an expert in the particular subject matter) could conduct research to identify sites on the Web which “speak” with credibility about the relevant subject matter. Such research could include, for example, conventional searching and browsing to identify such sites, analysis of traffic patterns and feed subscriptions, online and offline consumers surveys, etc.

Relevant and reliable information sources may also be identified by automated processes. For example, an automated process associated with the aggregator could monitor and analyze parameters indicative of site popularity or credibility. Such parameters could include, for example, traffic volume for particular sites, the number of RSS feed subscriptions for particular sites, and reputation metrics which are indicative of how the user community perceives an individual's or a site's relevance or credibility, or reflective of an individual's or site operator's behavior within the community. Direct user feedback regarding user satisfaction or experience with particular sites may also be solicited (e.g., by offering “thumbs up” and “thumbs down” voting links) and employed for this purpose. Such metrics may be mined from existing sources (including the sites themselves), or may be generated by the aggregator.

And regardless of whether the set of information sources is selected by a human operator or an automated process it may evolve over time. That is, the relevance and reliability of the sites to which the aggregator has subscribed may be monitored over time, e.g., periodically or on an ongoing basis, to ensure their continuing suitability for inclusion in the database. If the relevancy or reliability of a particular site declines over time, the corresponding feed subscription could be canceled in favor of a feed subscription to a more relevant, reliable site. As with the initial information source identification, this evolution may be directed by human operators, automated processes, or both. Again, solicitation of user feedback regarding their satisfaction with the information provided may be used to keep the information relevant and reliable. As with the voting links described above, this feedback may be explicitly solicited. Alternatively, user feedback may be implicit derived from user behavior. For example, such feedback may be derived from “click-through” data which represents selection by users of links corresponding to the most relevant information presented.

By aggregating and indexing only the most reliable and relevant information, embodiments of the present invention operate to close the knowledge gap between experienced and novice users of the Web. The present invention leverages the knowledge of the most experienced users for a given subject matter area, effectively providing a conduit for such knowledge from more experienced users to less experienced users, i.e., the users who would benefit most from access to such knowledge.

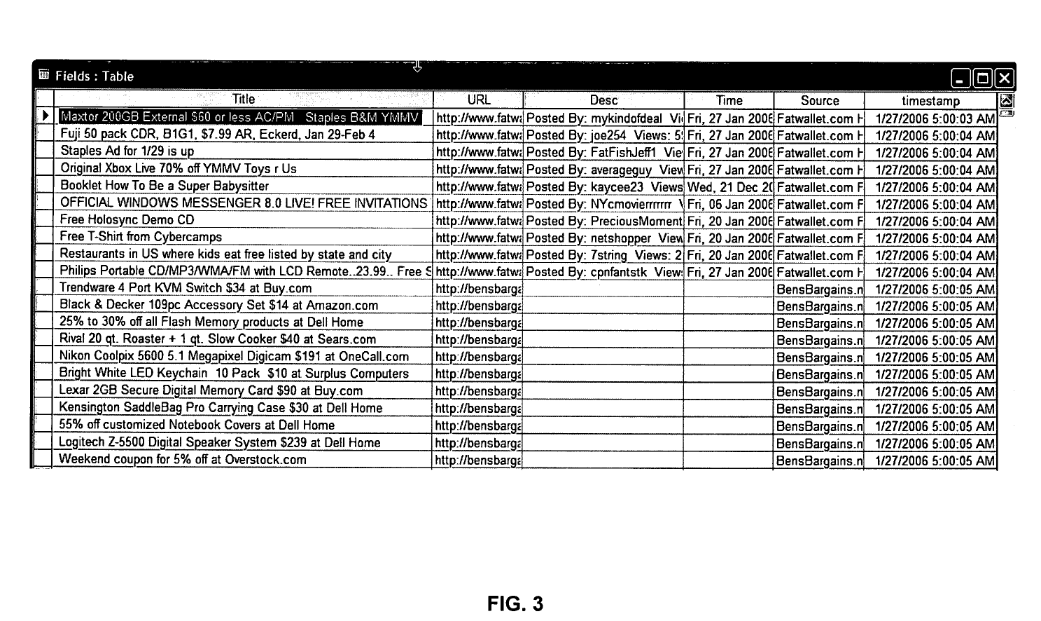

FIG. 3 is a table illustrating some exemplary records derived from a number of RSS feeds which may be aggregated and indexed according to a specific embodiment of the invention. As will be understood, the data may be stored using any of a wide variety of conventional and proprietary database schema and formats without departing from the invention. As can be seen, the RSS feeds which are used to populate this particular database relate generally to consumer electronics. Each record includes a title field which includes text from a recently received posting, a URL field which includes the URL corresponding to the posting, a description field which identifies the poster, a time field which records the time of the posting, a source field which identifies the Web site, and a timestamp field which records when the posting was indexed. It will be understood that the record fields depicted are merely exemplary and that additional fields and different combinations of these fields may be employed depending on the application.

According to some embodiments, additional measures may be taken to enhance the relevancy of the information aggregated according to the invention. According to a specific embodiment, before particular RSS feed data are indexed, a determination is made as to whether it should be indexed. That is, for example, the text in the title field of the data may be parsed to determine whether it is relevant to community of users to which the database is directed. However, it should be noted that, while such a determination may enhance the relevancy of the data in the database, it is not necessary to practice the invention.

As mentioned above, and according to some embodiments of the invention, the “freshness” of the information aggregated in the RSS feed database may be important for some applications. For example, time-sensitive offers and coupons may not be relevant more than a few days or even hours. Therefore, according to such embodiments, records are automatically deleted from the database (or otherwise made inaccessible) after some programmable threshold is reached, e.g., a period of time measured in days, minutes, hours, etc.

According to specific embodiments of the present invention, multiple RSS feed databases relating to different subject matter and/or communities may be maintained simultaneously (e.g., databases 106 of FIG. 1). Thus, relevant information may be simultaneously aggregated and provided to a wide diversity of communities of interest. As will be understood, these databases may be independent and distributed across the Internet, or portions of a single larger database stored across one or more servers.

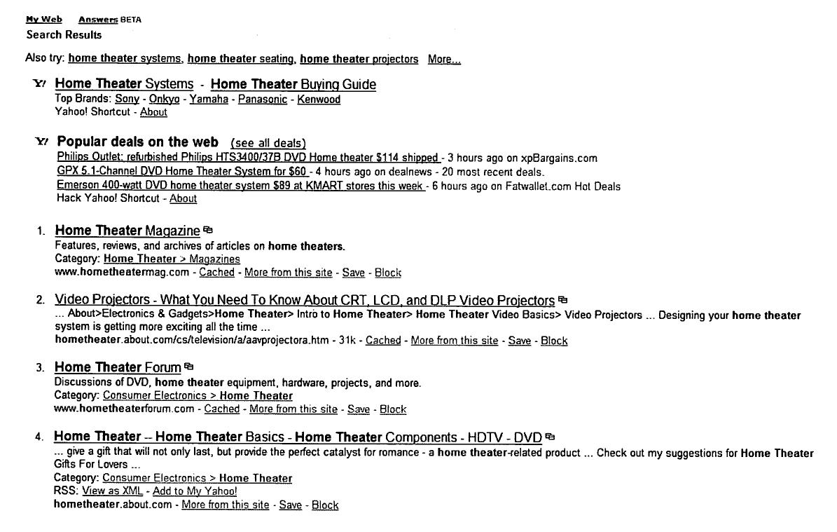

Portions of the information aggregated in an RSS feed database according to the present invention may be presented to users in a wide variety of ways. For example, as shown in the screen shot of FIG. 4, links to current deals (i.e., “Popular Deals on the Web”) relating to a search term entered by a user (in this case “home theater”) in a search engine, may be presented in conjunction with the conventionally obtained search results and sponsored links. The search term entered by the user is used as an index into a database populated with RSS feeds relating to, for example, consumer electronics. That is, in parallel with a conventional search of the Web, the search term is parsed for the purpose of identifying the relevant RSS feed database, which is then mined for relevant records.

According to various embodiments, presentation of information from the RSS feed database may only be invoked in response to use of specific search terms such as, for example, “bargain,” “coupon,” or “deal.” Alternatively, the information may be presented upon detection of search terms relating to the relevant subject matter, e.g., “home theater,” “airline reservations,” etc.

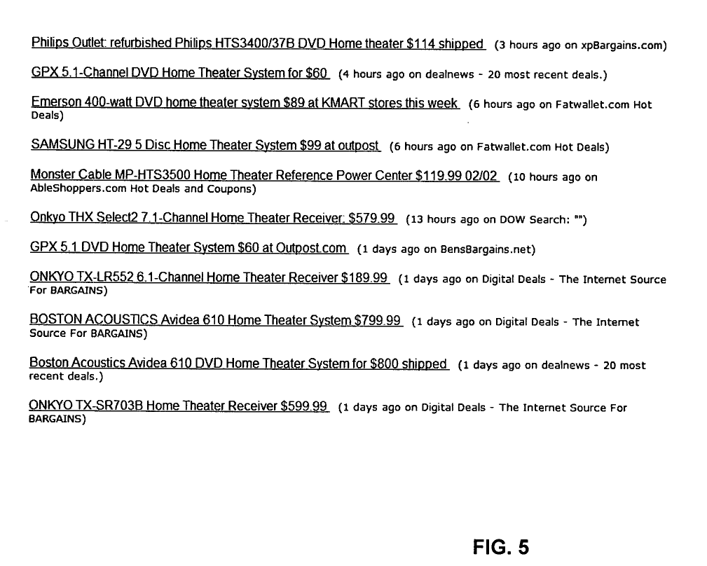

According to specific embodiments, and as shown in FIG. 4, only a subset of the relevant records may be represented in the initial search results page. In such a case, the user may then elect to see more relevant records by, for example, selecting the “(see all deals)” link to access the larger pool of current deals as shown in FIG. 5. According to a specific embodiment, selection of a particular entry results in presentation of the Web page to which the RSS feed record corresponds.

As will be understood, regardless of the interface in which they are presented, these entries may be ranked according to a wide variety of characteristics and/or algorithms. For example, entries may be ranked by relevancy (e.g., how closely the title field text relates to a search term), freshness (e.g., when the entry was posted), price (e.g., the record with the lowest $ amount in the title field), etc. As shown in FIGS. 4 and 5, the entries are ranked by time and include text associated with each identifying how long ago the posting occurred and on what site.

The results returned from the RSS feed database may also be filtered using a wide variety of techniques and parameters to further refine their relevancy. For example, in response to a search for deals relating to a particular product, the results returned from the RSS feed database may be limited only to online retailers. Alternatively, the results returned might be limited to brick-and-mortar retailers within a specified radius of the user's geographic position. Such filtering options may be specified by the user or, alternatively, be effected by an intelligent layer of processing between the user and the database.

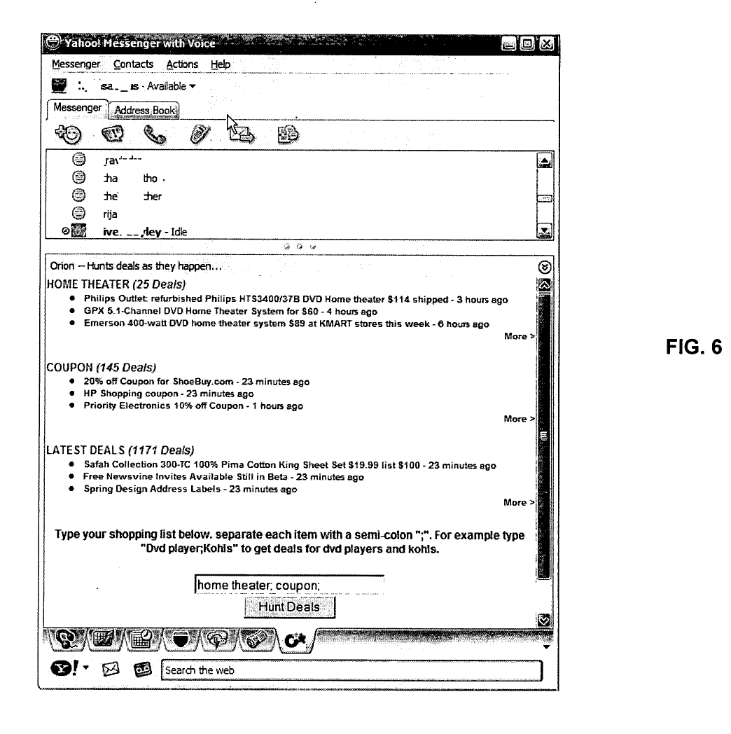

According to another embodiment, the information aggregated according to the present invention may be provided on an ongoing basis in any type of page or interface such as, for example, the Instant Messaging interface of FIG. 6. As shown, the user is provided with a text entry box in the interface in which search terms (e.g., “home theater,” and “coupon”) may be entered. In response to entry of these terms, current relevant records from the RSS feed database are presented in the messaging interface on an ongoing basis, thus allowing the user to track subject matter of interest. Presentation of this information in other types of interfaces is also contemplated. For example, when a user logs into a personalized home page on a Web portal or for an ISP, RSS feed database information may be presented in a portion of the interface as one of the customization options. According to various embodiments, such records may be presented virtually as they are indexed, periodically, or upon some specified action, e.g., launching or refreshing the interface.

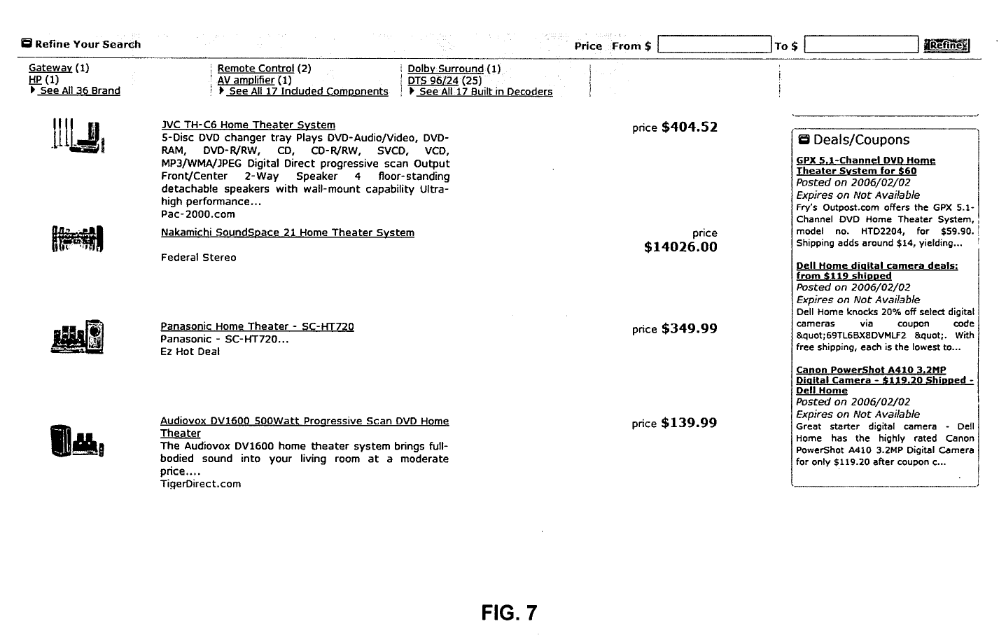

As yet another alternative, information aggregated according to the invention may be presented in response to a user search on a specific site. For example, as shown in FIG. 7, a user has entered the search term “home theater” on the Yahoo! shopping portal, in response to which current deals (Deals/Coupons), which may or may not be offered on the site being searched, are presented along with the expected search results. Alternatively, the current deal information may be presented in response to user navigation on such a site. That is, as the user traverses the category hierarchy, deals or any other information relating to the current browsing context may be presented.

According to a specific embodiment, selection of an entry in an interface which was generated from an RSS feed database record according to the present invention results in presentation of a page in which the terms of the deal presented relate in some way to the source of referral. For example, if the RSS feed database record corresponds to a coupon for a laptop computer, when the user selects the entry, the coupon code presented on the coupon provider's site corresponds to the entity maintaining the RSS feed database and presenting the deal link to the user. This enables the coupon provider and the source of referral to enter into revenue sharing arrangements.

The present invention may also be employed by providers of goods and service to monitor the market in which they participate. That is, for example, an online merchant specializing in consumer electronics may aggregate market information according to the invention (or subscribe to an aggregation service implemented according to the invention) for the purpose of monitoring movement in the markets for particular products or categories of products. This information would obviously be useful in determining business strategies in the relevant market.

While the invention has been particularly shown and described with reference to specific embodiments thereof, it will be understood by those skilled in the art that changes in the form and details of the disclosed embodiments may be made without departing from the spirit or scope of the invention. For example, embodiments of the invention have been described with reference to a centralized aggregation and indexing of information which is then presented to users over a network. However, embodiments are contemplated in which the invention may be practiced in a more distributed fashion. That is, for example, using peer-to-peer techniques, the aggregation, indexing, and presentation of information may be accomplished over many devices across a network. Alternatively, a single end user may practice the present invention. The scope of the invention should therefore not be limited by references to specific computing paradigms.

Moreover, specific embodiments of the present invention have been described with reference to the presentation of offers, coupons, or deals relating to consumer goods and/or services. However, it should be understood that the present invention is not so limited. Virtually any information available on a network may be aggregated and presented according to the invention. For example, current news stories may be indexed via subscription to the RSS feeds associated with news sites. Current postings to popular web logs may be similarly indexed. Real estate and rental listing is another area where the present invention could be effective. Information from vendor databases (which may or may not be affiliated with the aggregator) may also be indexed and presented. Thus, the present invention may be applied to aggregate and present information relating to a virtually limitless range of contexts, subject matter, and formats.

In addition, the various functionalities described herein may be implemented using any of a wide variety of software tools and deployed in any of a wide variety of computing and network architectures. Specific implementation details are not described herein as they are believed to be within the capabilities of those having skill in the relevant arts.

Finally, although various advantages, aspects, and objects of the present invention have been discussed herein with reference to various embodiments, it will be understood that the scope of the invention should not be limited by reference to such advantages, aspects, and objects. Rather, the scope of the invention should be determined with reference to the appended claims.

What is claimed is:

1. A computer-implemented method for aggregating and presenting information in a network, comprising:
identifying a plurality of information sources relating to a category of subject matter, each information source representing content from an associated site on the network, each site having at least one parameter associated therewith representative of reliability with respect to the category;
periodically receiving the content from each of the plurality of information sources;
indexing the content received from the information sources via the network in a database; and
presenting a portion of the content from the database to a user via the network, the portion of the content corresponding to an index specified by the user.

2. The method of claim 1 wherein at least some of the information sources comprise RSS feeds.

3. The method of claim 1 wherein the portion of the content is presented with search results generated in response to a search query from the user specifying the index.

4. The method of claim 1 wherein the portion of the content is presented as part of a Web page customized by the user.

5. The method of claim 1 wherein the content includes deal information relating to a plurality of products, and wherein the portion of the content presented to the user comprises the deal information corresponding to at least one of the plurality of products.

6. The method of claim 1 wherein the index is derived from a browsing context associated with the user, and wherein the portion of the content presented to the user is presented in combination with the browsing context.

7. The method of claim 1 wherein the content for each information source includes text posted on the corresponding site, a time at which the text was posted on the corresponding site, and a network address associated with the corresponding site.

8. The method of claim 1 further comprising evaluating the plurality of sites associated with the plurality of information sources over time with reference to the at least one parameter, and replacing selected ones of the information sources with additional information sources as a result of the evaluating.

9. The method of claim 8 wherein evaluating the plurality of sites comprises analyzing user feedback regarding the content provided from the database.

10. At least one computing device operable to aggregate and present information in a network, the at least one computing device comprising system memory, and at least one processor configured to:
identify a plurality of information sources relating to a category of subject matter, each information source representing content from an associated site on the network, each site having at least one parameter associated therewith representative of reliability with respect to the category;
periodically receive the content from each of the plurality of information sources;
index the content received from the information sources via the network in a database; and
present a portion of the content from the database to a user via the network, the portion of the content corresponding to an index specified by the user.

11. A computer-implemented method for aggregating and presenting information in a network, comprising:
facilitating specification of an index by a user on a client machine; and
facilitating presentation of a portion of content from a database on the client machine, the content corresponding to the index specified by the user and being derived from a plurality of information sources deployed on the network relating to a category of subject matter corresponding to the index, each of the information sources represented in the database corresponding to an associated site on the network having at least one parameter associated therewith representative of reliability with respect to the category.

12. The method of claim 11 wherein at least some of the information sources comprise RSS feeds.

13. The method of claim 11 wherein the index specified by the user is included in a search query generated by the user, and wherein the portion of the content is presented with search results generated in response to the search query.

14. The method of claim 11 wherein the portion of the content is presented as part of a Web page customized by the user.

15. The method of claim 11 wherein the content includes deal information relating to a plurality of products, and wherein the portion of the content presented to the user comprises the deal information corresponding to at least one of the plurality of products.

16. The method of claim 11 wherein the index is derived from a browsing context associated with the user, and wherein the portion of the content presented on the client machine is presented in combination with the browsing context.

17. The method of claim 11 wherein the portion of the content presented to the user includes text posted on a corresponding site, a time at which the text was posted on the corresponding site, and a link to the corresponding site.

18. A client computing device operable to present aggregated information received from a network, the client computing device comprising system memory, and at least one processor configured to:
facilitate specification of an index by a user of the client computing device; and
present a portion of content from a database on a display associated with the client computing device, the content corresponding to the index specified by the user and being derived from a plurality of information sources deployed on the network relating to a category of subject matter corresponding to the index, each of the information sources represented in the database corresponding to an associated site on the network having at least one parameter associated therewith representative of reliability with respect to the category.
